(19) United States
(12) Patent Application Publication
(10) Pub. No.: US 2024/0059536 A1
(43) Pub. Date: Feb. 22, 2024

(54) TRANSPORTER APPARATUS

(71) Applicant: W & D MCCULLOCH LTD., Ballantrae (GB)

(72) Inventor: William MCCULLOCH, Ballantrae (GB)

(73) Assignee: W & D MCCULLOCH LTD., Ballantrae (GB)

(21) Appl. No.: 18/271,436

(22) PCT Filed: Jan. 10, 2022
(86) PCT No.: PCT/GB2022/050029

§ 371 Date: Jul. 7, 2023

(30) Foreign Application Priority Data
Jan. 8, 2021 (GB) 2100275.3

(51) Int. Cl. B66F 9/12; B66F 9/22; B66F 9/18

(52) U.S. Cl. CPC B66F 9/12; B66F 9/22; B66F 9/184; B66F 9/187

(57) ABSTRACT

There is provided a transporter apparatus comprising a chassis (2) mounted upon at least two drive units (4). The drive units are arranged in parallel and define a space therebetween. The apparatus further comprises a motor (6) providing drive to at least one drive unit (4), and a lifting mechanism adapted to receive a load and move the load between the ground and a lifted position. The lifting mechanism comprises first and second guide bars (28), each guide bar having a first end attached to a drive unit (4) and a second end attached to the chassis (2). First and second lifting carriages (30) are slidingly mounted on a respective guide bar (28) and adapted to receive a portion of the load. First and second hydraulic rams (38) each have a first end attached to the chassis (2) and a second end attached to a respective lifting carriage (30).

### FIELD OF THE INVENTION

The present invention is an apparatus for transporting and deploying loads, such as flexible utility lines, containers and rolls of material, for example.

### BACKGROUND OF THE INVENTION

It is often necessary to carry loads to or around hard-to-access, remote and/or off-highway locations. Such locations include railway lines, wind farms and electricity transmission lines traversing remote terrain. If a new utility line such as a power cable is to be installed on a railway line, a drum carrying the cable is lifted into A-frame supports located upon a flatbed wagon. This lifting process may be carried out by a number of maintenance personnel or by a crane. However, even using a crane requires personnel to be present to ensure that the drum is located properly in the supports on the wagon. Thus, the personnel may be at risk of harm should anything go wrong whilst the drum is being installed on the wagon. This installation process can also take a significant amount of time to complete, thus leading to a time-consuming installation.

With sites such as wind farms and remote electricity transmission lines the drums carrying the utility lines are typically transported to the site on trucks. However, these on-highway trucks are often unable to access off-road locations due to their size, weight and lack of traction in off-road environments. Specialist off-highway trucks with greater traction than on-highway trucks may be used to access these remote final destinations but these can have a detrimental effect as they traverse the local environment due to their size and weight.

It is also the case that multiple apparatus may be required to transport different types of load. For example, an A-frame of the type mentioned above can be used to carry and deploy a utility line from a reel, but different apparatus would be needed to carry and/or deploy a roll of sheeting or a tank of liquid.

It is an aim of the present invention to obviate or mitigate one or more of these disadvantages with known transporter apparatus.

### SUMMARY OF THE INVENTION

According to the present invention there is provided a transporter apparatus comprising:
a chassis mounted upon at least two drive units, the drive units being arranged in parallel and defining a space therebetween;
a motor providing drive to at least one drive unit; and a lifting mechanism adapted to receive a load and move the load between the ground and a lifted position, the lifting mechanism comprising:
   first and second guide bars, each guide bar having a first end attached to a drive unit and a second end attached to the chassis;
   first and second lifting carriages, each lifting carriage slidingly mounted on a respective guide bar and adapted to receive a portion of the load; and
   first and second hydraulic rams, each ram having a first end attached to the chassis and a second end attached to a respective lifting carriage.

The at least two drive units may be continuous track units. Alternatively, the at least two drive units may be wheels.

The load may be a drum which can rotate about a drum axle, wherein each of the first and second lifting carriages is adapted to receive a respective end of the drum axle.

The apparatus may further comprise a drum axle for insertion into a drum such that the drum may rotate about the drum axle, wherein each of the
first and second lifting carriages is adapted to receive an end of the drum axle.

Each lifting carriage may include a hinged end cap adapted to close over and secure an end of the drum axle once the axle is received on the lifting carriage.

The guide bars may be inclined relative to the vertical, such that when a load is lifted by the lifting carriages it is moved upwards and towards a centre of gravity of the apparatus.

Each lifting carriage may include at least one recess adapted to receive portion of the load. The or each recess may include a bearing located therein.

Each lifting carriage may include a plurality of recesses arranged thereon such that the apparatus can lift loads of differing heights.

Each lifting carriage may include a locking member which can be secured over the or each recess so as to secure the load in a recess.

Each lifting carriage may include one or more fixing apertures adapted to receive a part of a load.

The apparatus may further comprise a platform which can be selectively attached to the lifting carriages, the platform comprising:
a load bed adapted to receive a load;
a pair of lifting arms extending upwardly from the load bed; and
a lifting pin projecting outwardly from a remote end of each of the lifting arms, each pin adapted to locate within a corresponding recess in one of the lifting carriages so as to attach the platform to the lifting carriages.

The apparatus may further comprise a dispenser for carrying and dispensing a roll of material, the dispenser comprising:
a concave trough portion adapted to receive the roll of material, the trough portion including a plurality of roller members adapted to rotate relative to the trough portion;
a pair of attachment arms extending from the trough portion, wherein each arm is adapted to be attached to a respective one of the lifting carriages; and
at least one guide roller pivotably connected to the attachment arms;
wherein the roller members and guide roller define a load space into which the roll of material is inserted.

The at least one guide roller may be biased towards the roller members.

The trough portion may include a ramp up which the roll of material may be rolled in order to enter the load space. The ramp may be pivotably attached to the trough portion.

The apparatus may further comprise a remote control adapted to control the motor and lifting mechanism.

The apparatus may further comprise a drum brake adapted to limit the rotational speed of a drum being carried by the apparatus. The drum brake may comprise a spring-loaded arm having a free end which engages with a drum being carried by the apparatus and applies a frictional force thereto.

### BRIEF DESCRIPTION OF THE DRAWINGS

A preferred embodiment of the present invention will now be described, by way of example only, with reference to the following drawings:

FIG. 1 is an exploded view of a first embodiment of a transporter apparatus;

FIG. 2 is a plan view of the apparatus shown in FIG. 1;

FIGS. 3(a)-(c) are front, side and rear views of the apparatus when receiving a utility line drum;

FIGS. 4(a)-(c) are front, side and rear views of the apparatus when transporting the utility line drum;

FIGS. 5 and 5(a) are views of a second embodiment of a transporter apparatus in conjunction with a load platform;

FIGS. 6(a) and 6(b) are end and side views of the load platform shown in FIG. 5;

FIG. 7 is a perspective view of a dispenser which can be carried by the transporter apparatus;

FIG. 8 is a perspective view of the dispenser of FIG. 7 when attached to a third embodiment of a transporter apparatus; and

FIG. 9 is the view of FIG. 8 when the dispenser is carrying a roll of material to be transported and/or dispensed.

### DETAILED DESCRIPTION OF THE DRAWINGS

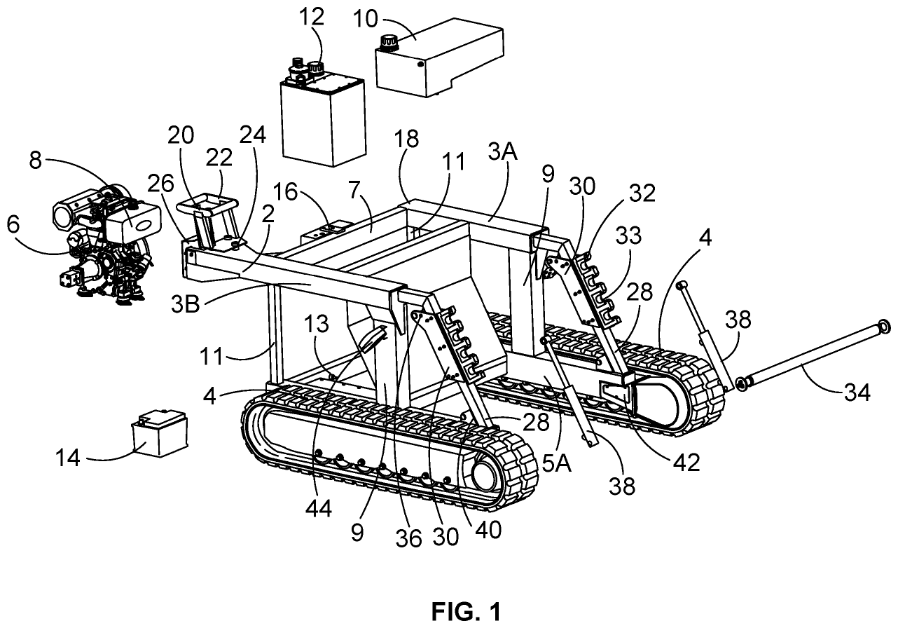

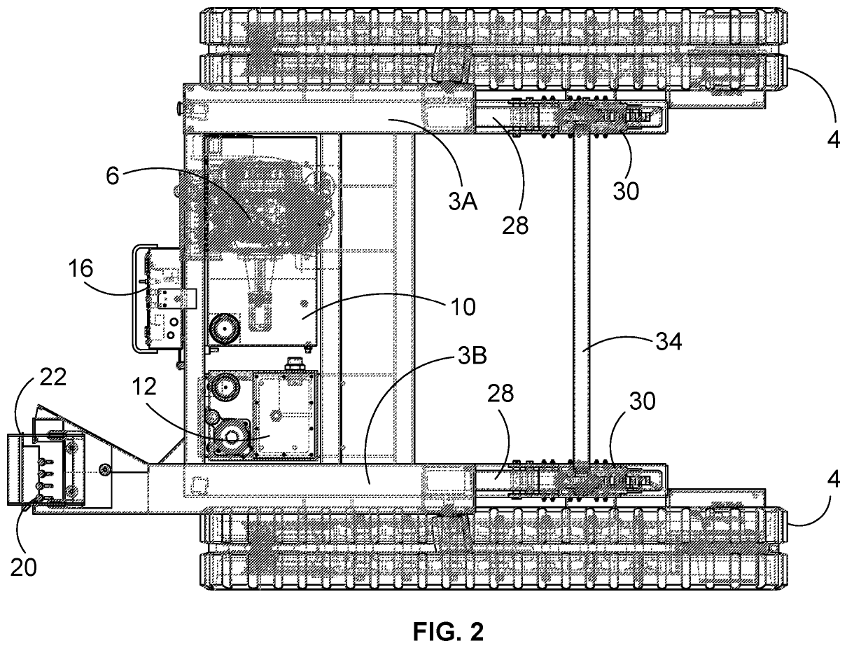

The exploded view of FIG. 1 and plan view of FIG. 2 show each of the key components of a first embodiment of a transporter apparatus. The apparatus comprises a frame, or chassis, 2 which is mounted to a pair of drive units 4 which provide drive or traction for the apparatus. The drive units 4 are arranged in parallel with one another and define a space or void between them. In the illustrated embodiment the drive units 4 are continuous track units. A motor 6 is mounted in the frame to provide drive to the tracks of the respective track units 4. The motor 6 is preferably an internal combustion engine but may alternatively be an electric motor. A hydraulic pump 8 is mounted on, and driven by, the engine 6. A fuel tank 10 and a hydraulic fluid reservoir 12 are also mounted to the frame 2, and fluidly connected to the engine 6 and pump, respectively. Electrical power is provided by a 12V battery 14.

The frame 2 comprises a pair of upper longitudinal rails 3A,3B and a pair of lower longitudinal rails 5A,5B. Each pair has a right rail and a left rail, those descriptions based on the point of view of someone standing at the rear of the apparatus facing forwards. The pair of left rails 3A,5A lie in substantially the same left plane, and the pair of right rails 3B,5B lie in substantially the same right plane. The pairs of left rails 3A,5A and right rails 3B,5B define the lateral extent of a space between the drive units that will house a drum when in use.

The track units 4 are mounted to the lower rails 5, whilst the upper rails 3A,3B are connected at their rear ends by an upper cross-member 7. Each upper rail 3A,3B is supported at its front end by a central support column 9, which extends upwards from a respective one of the lower rails 5A,5B. A rear support pole 11 extends vertically between the left and right pairs of lower and upper rails 3A,5A,3B,5B. A lower cross-member 13 connects the rear ends of the lower rails 5A,5B.

The apparatus is preferably remote controlled, such that no personnel need to be near the apparatus when it is operating. However, controls are provided on the frame 2 if proximate operation is desired. An engine control unit 16 is located on the upper cross-member 7. An emergency shut-off switch 18 is also provided where the upper cross-member 7 meets the left upper rail 3A. The right upper rail 3B is longer than the left upper rail 3A, whereby it projects a short distance rearwards from the remainder of the frame 2. Located on that projecting end of the right upper rail 3B are a plurality of control levers 20, which control the motion of the apparatus as well as the raising and lowering of a load carried by the apparatus. A protective surround 22 is provided to ensure that the levers 20 cannot be inadvertently operated. An anti-vibration bobbin 24 is located adjacent the levers 18 so as to isolate vibrations. A control valve 26 is also present for the hydraulics.

An inclined bar 28 extends from the front end of each upper rail 3A,3B to a front section of each track unit 4. The bars 28 act as guide rails for lifting carriages 30 which are slidingly mounted on each bar 28. Each carriage 30 has a plurality of recesses 32 which are intended to receive portions of the load to be carried, as will be explained in more detail below. A series of recesses 32 are provided on each carriage 30 so that loads of different heights and sizes can be carried by the apparatus. Within each recess 32 is a bearing 33 which allows the load portion, e.g. a drum axle 34 of a cable drum 50 to rotate with reduced friction.

Each carriage 30 is attached by an upper pin 36 to one end of a hydraulic ram 38. A lower pin 40 attaches the other end of each ram 38 to a bottom end of the inclined car 28. Operation of the rams 38 can thus slide the carriages 30 up and down their respective bars 28.

One or both track units 4 may include an access hatch 42 to allow access to the hydraulics housed therein. One or more work lights 44 may be provided on the chassis so as to assist night working. A curved or bent plate lies transversely across the frame so as to protect the engine and hydraulics system when a drum is being carried.

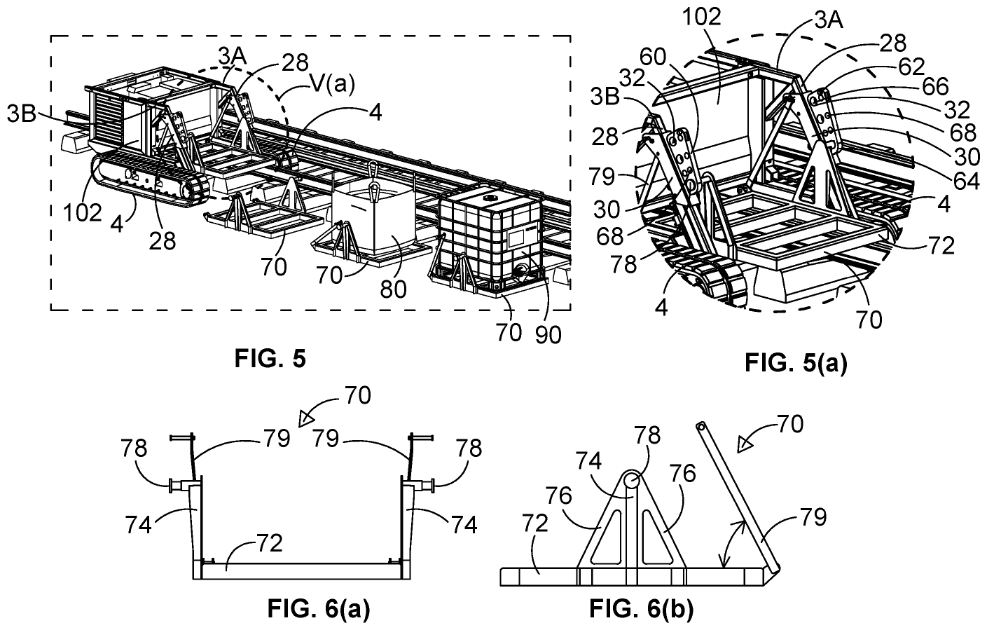

FIGS. 5 and 5(a) are views showing a second embodiment of a transporter apparatus as well as a load platform which can be used to carry different types of load. Although the second embodiment of the apparatus is visually different to the first embodiment it should be understood that it shares the same features as that shown in the preceding figures, unless otherwise stated. Those shared features share the same reference numbers and will not be described in detail again here.

The primary difference with the second embodiment is that most of the drive and ancillary components of the apparatus are enclosed within a body 102 instead of the open frame or chassis employed in the first embodiment. Otherwise, the second embodiment operates in substantially the same manner as the first embodiment.

An inclined bar 28 extends from the front end of each upper rail 3A,3B to a front section of each track unit 4. The bars 28 act as guide rails for lifting carriages 30 which are slidingly mounted on each bar 28. Each carriage 30 has a plurality of recesses 32 which are intended to receive portions of the load to be carried, as will be explained in more detail below. A series of recesses 32 are provided on each carriage 30 so that loads of different heights and sizes can be carried by the apparatus. Within each recess 32 may be a bearing which allows the load portion, e.g. a drum axle 34 of a cable drum 50, to rotate with reduced friction.

A modification has been made to each lifting carriage 30 of the second embodiment so as to include a locking member 60. Each locking member 60 is connected at one end to its respective lifting carriage 30 by a hinge pin 62 so that the locking member can open and close about a hinge relative to the carriage. The opposite end of the locking member 60 from the hinge pin 62 has a lock 64 which can lock the locking member in the closed position. Each locking member 60 has a plurality of recesses 66 which cooperate with the recesses 32 of the carriage 30 so as to form a circular or similar shaped opening when the locking member 60 is in the closed position over the carriage 30. The locking members 60 and/or the lifting carriages 30 may also include one or more fixing apertures 68 which can be used in place of, or in addition to, the recesses in order to attach portions of a load to the apparatus. The locking members can also be employed in the other embodiments of the transporter apparatus described herein.

A number of load platforms 70 are also shown in FIGS. 5 and 5(a). As seen in FIG. 5 these platforms 70 can be used to carry a variety of different loads, such as bulk bags 80 and liquid tanks 90 for example.

FIGS. 6(a) and 6(b) show the load platform 70 in more detail. Each platform 70 comprises a substantially flat load bed or base 72 upon which a load can be mounted. Halfway along each side of the load bed 72 is a lifting arm 74, which projects upwards from the load bed. Each lifting arm 74 may be supported on either side by a pair of buttresses 76. A remote, or upper, end of each lifting arm 74 has a lifting pin 78, which extends outwardly from the lifting arm in a direction transverse to a longitudinal axis of the platform 70. Each platform 70 has an inner end 71, which is the end which will be adjacent the body 102 when the platform 70 is being carried by the apparatus. The inner end 71 may include a pair of brace members 79, which are located at either side of the platform and can pivot relative thereto. As seen best in FIG. 5(a) a remote end of each brace member 79 can be attached to a respective lifting carriage 30 to ensure that the bed 72 remains substantially horizontal when being lifted and carried by the apparatus.

The platform 70 is attached to the lifting carriages 30 by the pair of lifting pins 78, which locate in a corresponding recess 32 in one of the lifting carriages.

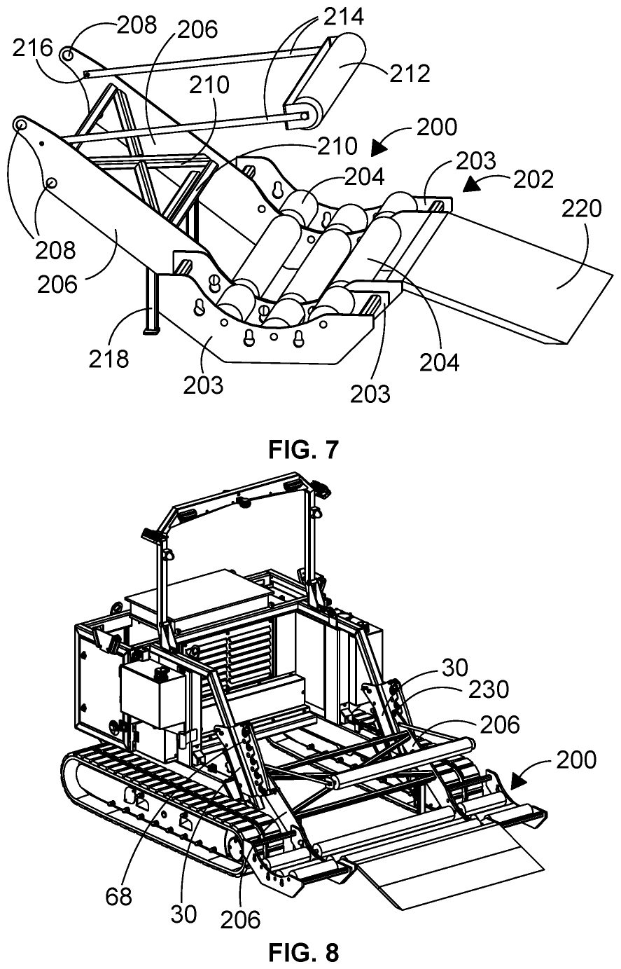

A dispenser which may be used with any of the embodiments of transporter apparatus described herein is shown in FIGS. 7-9. The dispenser 200 can be attached to the transport apparatus in order to carry and dispense rolls of material. Referring initially to FIG. 7 the dispenser has a concave trough, or base, portion 202 adapted to receive a roll of material. The trough portion 202 may be of unitary construction but in the preferred embodiment illustrated it is made up of a number of curved or concave plates 203 which are spaced from one another in a transverse direction. Located within the trough portion 202 are a plurality of roller members 204 which are adapted to rotate relative to the trough portion. Each roller member 204 has an axis of rotation which is transverse to a longitudinal axis of the dispenser, and in the illustrated embodiment the ends of each roller member are connected to respective plates 203.

A pair of attachment arms 206 extend away from the trough portion 202 in the longitudinal direction. The end of each arm 206 which is remote from the trough portion is adapted to be attached to a respective one of the lifting carriages. In the illustrated embodiment this is achieved by providing one or more fixing apertures 208 adjacent the remote end of the arm 206. One or more bracing members 210 may extend between the two arms 206 in order to provide support and rigidity if needed.

A guide roller 212 is pivotably attached to the attachment arms 206 by a pair of rods 214. The guide roller 212 can rotate relative to the rods 214 and has an axis of rotation which is substantially parallel to those of the roller members 204 in the trough portion 202. The rods 214 are attached to the attachment arms 206 by pivot pins 216 and biasing means such as torsion springs (not shown) may be provided at the pivot pins in order to bias the guide roller 212 in a downward direction towards the trough portion 202.

Support legs 218 may be provided on the underside of the dispenser 200 to provide support and stability when the dispenser is on the ground. A fixed or hinged ramp 220 may also be provided so as to make it easier to insert a roll of material into the trough portion 202.

FIG. 8 shows the dispenser 200 attached to the remainder of a transporter apparatus. Again, this third embodiment of the apparatus may appear visually different to the preceding embodiments but it shares the same key components and operates in the same way unless otherwise stated.

The dispenser 200 is attached to the lifting carriages 30 via the attachment arms 206. Mechanical fixtures 230 are inserted through the fixing apertures 208 in the arms 206 and into corresponding apertures 68 provided in the lifting carriages 30.

Alternatively, the fixtures may be received in the recesses within the lifting carriages 30.

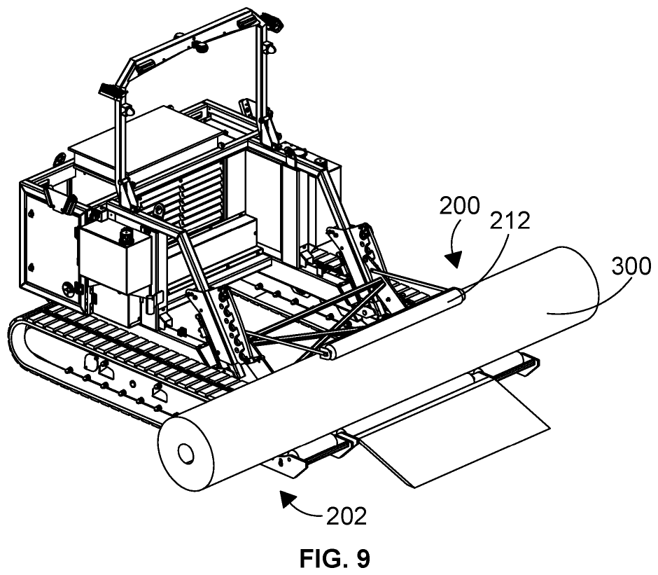

FIG. 9 shows the dispenser 200 with a roll of material 300 located within the trough portion 202 and ready to be transported and/or dispensed therefrom. As can be seen the roll of material 300 sits within a load space defined between the roller members in the trough portion 202 and the guide roller 212 above the trough portion.

The guide roller 212 presses down on the roll of material 300 to ensure the correct tension is applied to the material when it is being dispensed.

### INDUSTRIAL APPLICABILITY

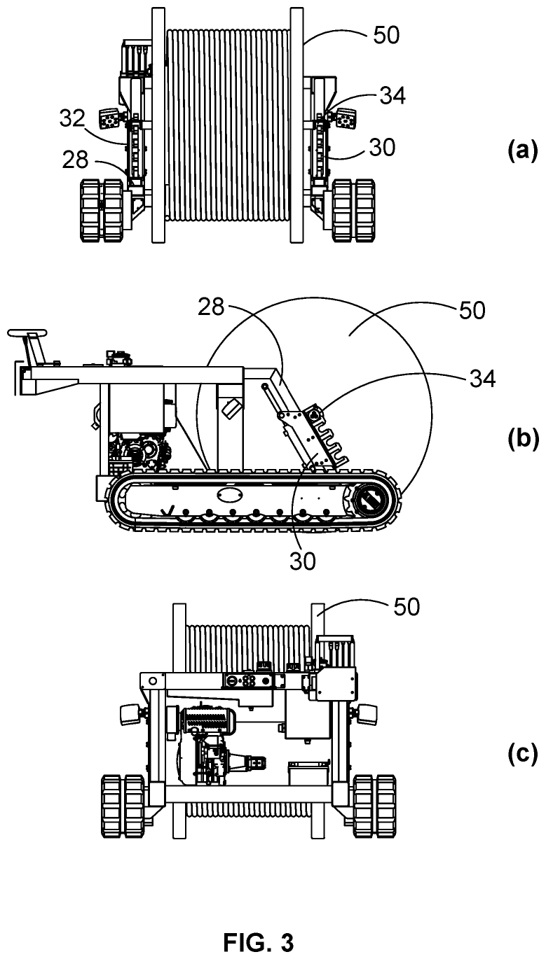

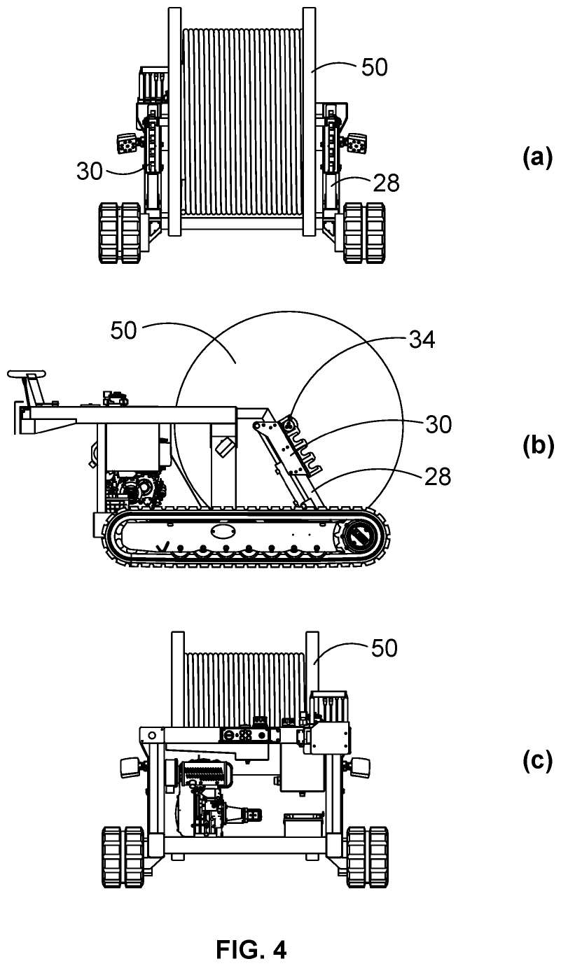

The manner in which the transporter apparatus operates will now be described, initially with reference to FIGS. 3 and 4 where the apparatus is being used to carry a utility line.

Initially a drum 50 carrying the required utility line (e.g. power cable, hose, flexible ducting) will be deposited on the ground, ready for collection by the apparatus. The drum 50 is of a known type and will have a central aperture extending transversely through the drum. The drum axle rod 34 will be passed through the central aperture so that the ends of the rod project from either side of the drum 50. The apparatus is started up, and the hydraulic circuit is activated so as to move the lifting carriages 30 to their lowest position on the guide bars 28. The apparatus is then manoeuvred via the control levers 20 or remote control unit (not shown) to a position wherein the ends of the rod axle 34 are adjacent the lifting carriages 30. The apparatus then crawls forward until the rod ends enter the appropriate recesses 32 and bearings 33 on each carriage 30. This is the position shown in FIGS. 3(a)-(c), where the drum 50 is located in the space defined between the two drive units 4. It can also be seen in these figures that the drum 50 is the largest drum which can be carried by the apparatus, as the rod 34 is located in the uppermost recess 32 of each carriage 30. For railway applications the largest drum the apparatus will need to carry has a 1400 mm flange diameter. However, the apparatus can be scaled up as needed if drums larger than this are needed in other operational applications.

End caps (not shown) may be hinged to each carriage 30. Once the rod ends are located in the carriage recesses 32, the end caps can be closed over the rod ends and secured in order to prevent any lateral movement of the rod 34 as the machine traverses uneven terrain. The hydraulic circuit is then activated to raise the carriages 30 on the guide bars 28. As the guide bars 28 are inclined backwards relative to the vertical, raising the carriages 30 not only lifts the drum off the ground but also moves the drum backwards towards the centre of the apparatus. This ensures that the drum 50 is carried with a low centre of gravity within the chassis 2, optimising stability and maximising lifting capacity. Whether held by the lifting mechanism on the ground or raised above the ground the drum remains in the space between the drive units and between the left and right planes defined by the pair of left rails 3A,5A and the pair of right rails 3B,5B. FIGS. 4(a)-(c) show the apparatus with the carriages 30 and drum 50 in the raised position.

Once the drum 50 is in the raised position the hydraulic circuit locks the rams 38 such that the carriages 30 and the drum cannot drop downwards. The apparatus can now transport the drum to a desired location. This may be on a railway line or in an off-road location such as near a wind farm, for example.

When the apparatus reaches the location from which the utility line is to be run a free end of the utility line is anchored or held at the starting location. The apparatus then moves away from the starting location in the direction in which the line is to be run. The drum 50 and axle rod 34 are free to rotate and so as the apparatus moves away from the starting location the drum will rotate, feeding out the utility line. A drum brake (not shown) may be provided in order to limit the rotational speed of the drum. The brake may comprise a spring-loaded arm having a distal end pivotably attached to the chassis. A proximal end of the arm may have a brake shoe or wheel which engages upon the drum and controls the rotational speed of the drum through friction.

Once the utility line has been deployed the apparatus can deposit the empty drum at a given location by reversing the lifting procedure described above.

The operation of the transporter apparatus when using a load platform of the kind shown in FIGS. 5 and 6 will now be described, where the operation is similar to that described above save for the load being carried.

Initially a platform 70 carrying the required load (e.g. bulk bag, metal plate, liquid tank) will be deposited on the ground, ready for collection by the apparatus. The apparatus is started up, and the hydraulic circuit is activated so as to move the lifting carriages 30 to their lowest position on the guide bars 28. The apparatus is then manoeuvred via the control levers 20 or remote control unit (not shown) to a position wherein the lifting pins 78 of the platform 70 are adjacent the respective lifting carriages 30. The apparatus then crawls forward until the lifting pins 78 enter the appropriate recesses 32 and bearings 33 on each carriage 30.

Once the lifting pins 78 are located in the carriage recesses 32, the locking members 60 are closed over the recesses 32 and locked in place in order to prevent any movement of the pins 78 out of the recesses as the machine traverses uneven terrain. The hydraulic circuit is then activated to raise the carriages 30 on the guide bars 28. As the guide bars 28 are inclined backwards relative to the vertical, raising the carriages 30 not only lifts the platform 70 off the ground but also moves it backwards towards the centre of the apparatus. This ensures that the platform 70 and load thereon are carried with a low centre of gravity within the chassis 2, optimising stability and maximising lifting capacity. Whether held by the lifting mechanism on the ground or raised above the ground the platform remains in the space between the drive units and between the left and right planes defined by the pair of left rails 3A,5A and the pair of right rails 3B,5B. FIGS. 5 and 5(a) show the apparatus with the carriages 30 and platform 70 in the raised position.

Once the platform 70 is in the raised position the hydraulic circuit locks the rams 38 such that the carriages 30 and the platform cannot drop downwards. The apparatus can now transport the platform and load to a desired location. This may be on a railway line or in an off-road location such as near a wind farm, for example.

When the apparatus reaches the location where the load is to be deposited the apparatus can deposit the load and platform by reversing the lifting procedure described above.

The operation of the transporter apparatus when using a dispenser of the kind shown in FIGS. 7-9 will now be described, where the operation is again very similar to that described above save for the load being carried.

Initially a roll of material 300 to be dispensed will be deposited on the ground, ready for collection by the apparatus. The apparatus will then be brought into a position where the dispenser 200 can be attached thereto, unless it is already attached.

Once the dispenser is attached to the lifting carriages by the mechanical fixtures 230 in the manner described above, the apparatus is manoeuvred via the control levers 20 or remote control unit (not shown) to a position wherein the trough portion 202 of the dispenser is adjacent the roll of material 300. The roll of material 300 is then lifted, or rolled, into the trough portion, using the ramp 220 to assist if present. With the roll of material 300 located in the trough portion 202 the guide roller 212 presses down on the top of the roll, as shown in FIG. 9.

With the roll 300 located in the dispenser the hydraulic circuit is activated to raise the carriages 30 on the guide bars 28. As the guide bars 28 are inclined backwards relative to the vertical, raising the carriages 30 not only lifts the dispenser 200 and roll 300 off the ground but also moves them backwards towards the centre of the apparatus.

Once the dispenser 200 is in the raised position the hydraulic circuit locks the rams 38 such that the carriages 30 and the dispenser cannot drop downwards. The apparatus can now transport the roll 300 to a desired location. This may be on a railway line or in an off-road location such as near a wind farm, for example.

When the apparatus reaches the location from which the material is to be run a free end of the material is anchored or held at the starting location. The apparatus then moves away from the starting location in the direction in which the line is to be run. The roll of material 300 is free to rotate in the trough portion 202 thanks to the roller members 204 and so as the apparatus moves away from the starting location the roll will rotate, feeding out the material. As described above, the guide roller 212 ensures that the proper tension is kept on the material as it is deployed.

Once the material has been deployed the apparatus can deposit the roll core at a given location by reversing the lifting procedure described above, or the roll core may be light enough that it can be removed from the dispenser by hand.

The present invention ensures that there is no need for any operational personnel to be in the vicinity of the apparatus when a load is being transported and/or deployed. Thus, no personnel are placed at risk during these operations. The present invention also provides a simple lifting and transporting process with no need for multiple personnel, thus reducing the time taken to complete these processes. The relatively small size and weight of the present invention also ensures that damage to the local environment is also avoided, or at least minimised.

The maximised lifting capacity provided by the angled lifting mechanism of the present invention minimises the size of the machine, thereby reducing material and manufacturing cost. It also reduces the logistics costs required to transport the equipment, and enables easier access to railway infrastructure, an off-highway work site or the like. Receiving and transporting a load in a space between the drive units provides a level of protection for the load and any personnel who need to be in the vicinity of the machine. It also ensures that the apparatus can remain relatively compact in spite of the loads being carried.

The apparatus can transport utility line drums up to 930 mm wide. For narrower drums, axle bushings and spring collars can be threaded onto the axle rod ends to minimise any lateral movement of the drum on the axle rod.

The apparatus comprises at two drive units, and may have more if a given application requires it. Instead of continuous tracks the drive units may comprise wheels.

Whilst the guide bars are preferably inclined as in the preferred embodiment they may alternatively be substantially vertical and raise and lower the load in a substantially vertical direction. In this instance the guide bars are located further back on the chassis and as close to the centre of gravity of the apparatus as possible.

Instead of being a spring-loaded arm the optional drum brake may be a brake shoe or pad adapted to be applied to the drum under centrifugal force if the rotational speed of the drum exceeds a predetermined limit.

These and other modifications and improvements may be incorporated without departing from the scope of the present invention.

1. A transporter apparatus comprising:
a chassis mounted upon at least two drive units, the drive units being arranged in parallel and defining a space therebetween;
a motor providing drive to at least one drive unit; and
a lifting mechanism adapted to receive a load and move the load between the ground and a lifted position, the lifting mechanism comprising:
first and second guide bars, each guide bar having a first end attached to a drive unit and a second end attached to the chassis;
first and second lifting carriages, each lifting carriage slidingly mounted on a respective guide bar and adapted to receive a portion of the load; and
first and second hydraulic rams, each ram having a first end attached to the chassis and a second end attached to a respective lifting carriage.

2. The apparatus of claim 1, wherein the at least two drive units are continuous track units.

3. The apparatus of claim 1, wherein the load is a drum which can rotate about a drum axle, wherein each of the first and second lifting carriages is adapted to receive a respective end of the drum axle.

4. The apparatus of claim 1, further comprising a drum axle for insertion into a drum such that the drum may rotate about the drum axle, wherein each of the first and second lifting carriages is adapted to receive an end of the drum axle.

5. The apparatus of claim 3, wherein each lifting carriage includes a hinged end cap adapted to close over and secure an end of the drum axle once the axle is received on the lifting carriage.

6. The apparatus of claim 1, wherein the guide bars are inclined relative to the vertical, such that when a load is lifted by the lifting carriages it is moved upwards and towards a centre of gravity of the apparatus.

7. The apparatus of claim 1, wherein each lifting carriage includes at least one recess adapted to receive portion of the load.

8. The apparatus of claim 7, wherein each recess includes a bearing located therein.

9. The apparatus of claim 7, wherein each lifting carriage includes a plurality of recesses arranged thereon such that the apparatus can lift loads of differing heights.

10. The apparatus of claim 7, wherein each lifting carriage includes a locking member which can be secured over the or each recess so as to secure the load in a recess.

11. The apparatus of claim 1, wherein each lifting carriage includes one or more fixing apertures adapted to receive a part of a load.

12. The apparatus of claim 1, further comprising a platform which can be selectively attached to the lifting carriages, the platform comprising:
a load bed adapted to receive a load;
a pair of lifting arms extending upwardly from the load bed; and
a lifting pin projecting outwardly from a remote end of each of the lifting arms, each pin adapted to locate within a corresponding recess or aperture in one of the lifting carriages so as to attach the platform to the lifting carriages.

13. The apparatus of claim 1, further comprising a dispenser for carrying and dispensing a roll of material, the dispenser comprising:
a concave trough portion adapted to receive the roll of material, the trough portion including a plurality of roller members adapted to rotate relative to the trough portion;
a pair of attachment arms extending from the trough portion, wherein each arm is adapted to be attached to a respective one of the lifting carriages; and
at least one guide roller pivotably connected to the attachment arms;
wherein the roller members and guide roller define a load space into which the roll of material is inserted.

14. The apparatus of claim 13, wherein the at least one guide roller is biased towards the roller members.

15. The apparatus of claim 13, wherein the trough portion includes a ramp up which the roll of material may be rolled in order to enter the load space.

16. The apparatus of claim 15, wherein the ramp is pivotably attached to the trough portion.

17. The apparatus of claim 1, further comprising a remote control adapted to control the motor and lifting mechanism.

18. The apparatus of claim 1, further comprising a drum brake adapted to limit the rotational speed of a drum being carried by the apparatus.

19. The apparatus of claim 18, wherein the drum brake comprises a spring-loaded arm having a free end which engages with a drum being carried by the apparatus and applies a frictional force thereto.
